(19) United States
(12) Patent Application Publication
(10) Pub. No.: US 2026/0084155 A1
(43) Pub. Date: Mar. 26, 2026

(54) Pierceable Plugin Cap Suited for Use with Pressure Sensitive Pipette System

(71) Applicant: Blackfly Investments, LLC, dba Molecular Testing Labs, Vancouver, WA (US)

(72) Inventors: Mariko Nakano, Vancouver, WA (US); Ryan Baran-Maguire, Portland, OR (US)

(21) Appl. No.: 18/894,761

(22) Filed: Sep. 24, 2024

(51) Int. Cl. B01L 3/00; G01N 35/10

(52) U.S. Cl. CPC B01L 3/50825; G01N 35/1074; G01N 35/1079

(57) ABSTRACT

A pierceable plugin cap for a specimen tube for use in an automated specimen tube testing system in a laboratory environment. The pierceable plugin cap comprises a cylindrical plugin aperture having a top end, a bottom end and a plugin aperture body disposed between the top end and the bottom end. The pierceable plugin cap further comprises a plurality of sealing rings disposed on an outer circumference of the plugin aperture body for securing the plugin aperture body to a specimen tube aperture in a water-tight sealed manner. The pierceable plugin cap further comprises a membrane (typically a foil membrane) disposed over the top end to cover the plugin aperture to form a liquid tight seal wherein the membrane configured to be pierced by a pipette such that the piercing pipette may pass through the plugin cap aperture.

### BACKGROUND

As techniques and methodologies for medical testing and diagnostics advance, more consumers are turning to “at-home” collection kits that may involve collecting human material samples, such as blood, urine or saliva, using a collection device without the assistance of a physician/medical staff. In a typical procedure, a patient will induce a blood flow or urine flow into a dedicated collection medium, such as a cup or other receptacle. As is known in the profession, samples collected remotely can then be packaged for mailing or transit to a remote testing facility. At a testing facility, the remotely collected samples may be prepared and tested whereby results of testing or diagnostics may then be communicated to the patient using standard confidentiality protocols.

At the testing facility, the received samples can be processed and prepared using collection and preparation tubes as is standard in the industry. These tubes (e.g., common laboratory test tubes) may have a hard cap that engages the open end of the tube for securing the sample contents inside the tube for in-house maneuvering and storing. When samples are ready for testing and diagnostics, an automated pipette system may be used to dispense test and preparation materials into each tube in an array of tubes with samples. Thus, when a lab technician wishes to work with the sample tubes in the array, the hard cap must be removed (e.g., unscrewed) from each tube. In a system more suited for automation, this human interaction with each tube is time consuming and inefficient.

### BRIEF DESCRIPTION OF THE DRAWINGS

Embodiments of the subject matter disclosed herein in accordance with the present disclosure will be described with reference to the drawings, in which:

FIG. 1 is an isometric diagram of a pierceable plugin cap suited for use with pressure sensitive pipette system according to an embodiment of the subject matter disclosed herein;

FIG. 2 is a plan view of the pierceable plugin cap of FIG. 1 according to an embodiment of the subject matter disclosed herein;

FIG. 3 is the bottom view of the pierceable plugin cap of FIG. 1 according to an embodiment of the subject matter disclosed herein;

FIG. 4 is a plan view of a common specimen tube suited for use with the pierceable plugin cap of FIG. 1 according to an embodiment of the subject matter disclosed herein;

FIG. 5 is a plan view of a common specimen tube about to be engaged with the pierceable plugin cap of FIG. 1 according to an embodiment of the subject matter disclosed herein;

FIG. 6 is a plan view of a common specimen tube engaged with the pierceable plugin cap of FIG. 1 according to an embodiment of the subject matter disclosed herein; and

FIG. 7 is a system view of an automated pipette system suited for use with an array of specimen tubes each fitted with the pierceable plugin cap of FIG. 1 according to an embodiment of the subject matter disclosed herein.

Note that the same numbers are used throughout the disclosure and figures to reference like components and features.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the devices described herein may be practiced. These devices may, however, be embodied in many different forms and should not be construed as limited to the embodiments set forth herein; rather, these embodiments are provided so that this disclosure will satisfy the statutory requirements and convey the scope of the subject matter to those skilled in the art.

By way of an overview, the systems and devices discussed herein are directed to a pierceable plugin cap for a specimen tube for use in an automated specimen tube testing system in a laboratory environment. In one embodiment, the pierceable plugin cap comprises a cylindrical plugin aperture having a top end, a bottom end and a plugin aperture body disposed between the top end and the bottom end, wherein the bottom end comprises a diameter that is smaller than the top end. This allows the pierceable plugin cap to be more easily inserted into a respective specimen tube. The pierceable plugin cap further comprises a plurality of sealing rings disposed on an outer circumference of the plugin aperture body, the plurality of sealing rings configured to secure the plugin aperture body to a specimen tube aperture in a water-tight sealed manner. The pierceable plugin cap further comprises a membrane (typically a foil membrane) disposed over the top end to cover the plugin aperture to form a liquid tight seal, the membrane configured to be pierced by a pipette such that the piercing pipette may pass through the plugin cap aperture.

In this manner, the pierceable plugin cap is more readily suited to be used in an automated materials handling and testing system. Pipettes for dispensing materials into each specimen tube may be maneuvered into respective specimen tubes by penetrating the foil membrane (typically a low-level force, such as 2.4 Newtons) that reduces stress on the pipettes and the specimen tubes. The foil membrane with only a penetration hole of the same size as the pipette also remains in place to maintain any materials inside the specimen tube (such as, e.g., a swab stick) when the pipette is retracted. The improvements lead to a more efficient testing system that is not compromised by swab sticks being pulled out of specimen tube, thereby interrupting automation.

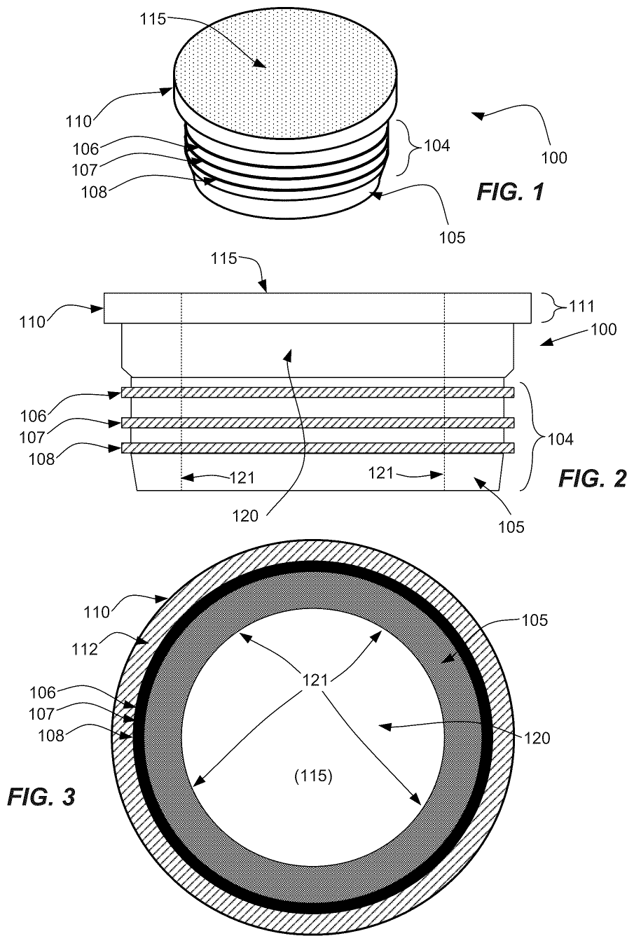

These and other aspects are discussed below with respect to FIGS. 1-7.

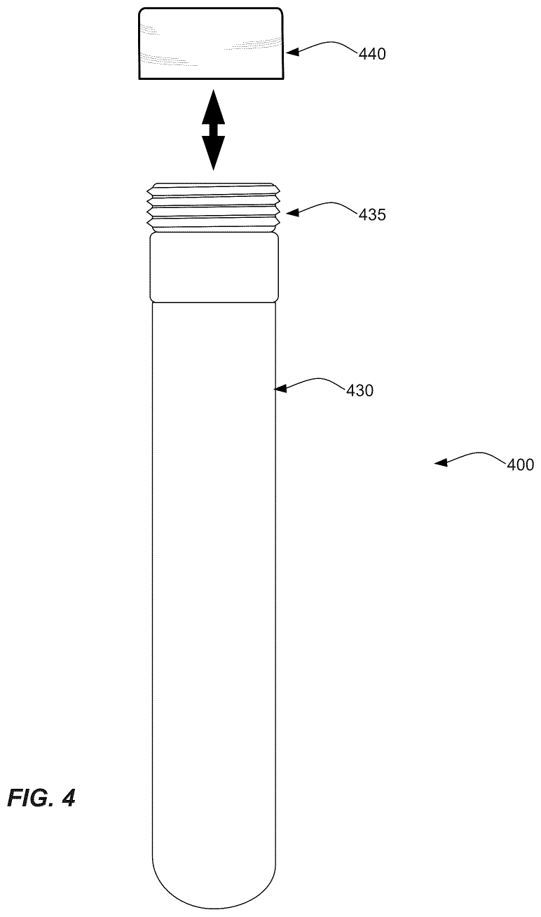

FIG. 1 is isometric diagram of a pierceable plugin cap 100 suited for use with pressure sensitive pipette system in a clinical diagnosis laboratory according to an embodiment of the subject matter disclosed herein. In an embodiment, the plugin cap 100 may be sized to securely fit in a top (open) end of a laboratory specimen tube or test tube (“specimen tube” hereinafter). Engagement between the plugin cap 100 and a specimen tube is discussed further below with respect to FIGS. 4-6. The plugin cap 100 comprises a narrow end 105 having a diameter suited to fit inside a standard specimen tube. Further, the narrow end 105 is slightly tapered to facilitate entry into the open end of a specimen tube and is the culmination of a shaft portion 104 of the plugin cap 100 suited to securely fit inside the specimen tube. The plugin cap 100 further comprises a top end 110 that has a diameter that is larger than the open aperture of a specimen tube such that when the plugin cap 100 is inserted into the specimen tube aperture, the top end comes into to contact with the lip of the specimen tube aperture and prevents the plugin cap 100 from being pushed beyond the threshold of the specimen tube aperture. That is, the plugin cap 100 cannot be inserted beyond the top of the specimen tube and the portion of the plugin cap that remains protruding above the specimen tube aperture threshold is about 0.8-1.0 mm.

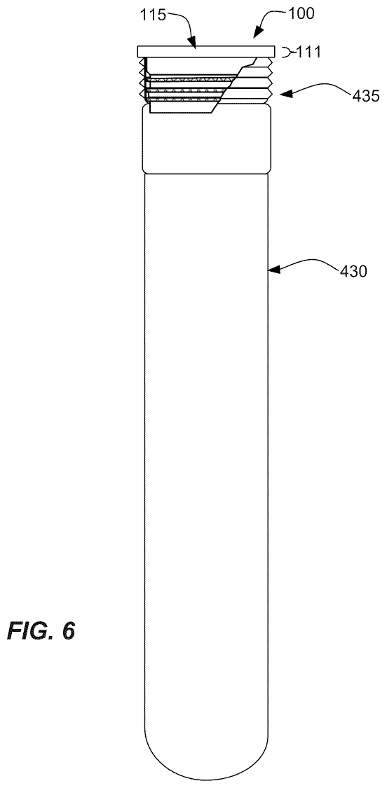

The shaft 104 of the plugin cap 100 may also include a plurality of sealing rings 106, 107, and 108 for engaging an inner circumference of the specimen tube when inserted to provide a liquid-tight seal. Thus, the sealing rings 106, 107, and 108 each provide a means for securing (via compression) the plugin cap 100 inside the top of the specimen tube and prevents materials (e.g., liquid) from getting in or out when the plugin cap 100 is securely inserted. The plug cap 100 sealing rings 106, 107, and 108 are sized to allow for a human to push the plugin cap into the specimen tube and to pull the plugin cap 100 out of the specimen tube with relative ease. The plugin cap 100 may be more secured in the inserted position by placing a screw-on cap (see FIG. 6) over the plugin cap 100 for transport or rougher handling. In this embodiment, three sealing rings 106, 107, and 108 are shown, but other embodiments have more or fewer than three sealing rings 106, 107, and 108.

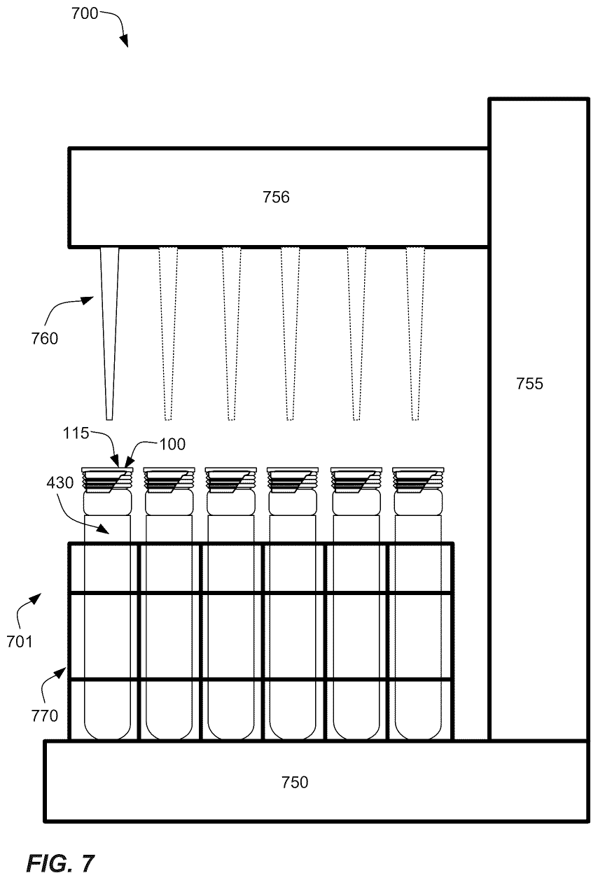

The plugin cap 100 of FIG. 1 includes a membrane 115 covering an aperture (shown in FIGS. 2 and 3) formed by the cylindrical plugin cap 100 which allows for piercing by automated pipette systems (shown in FIG. 7) while mitigating stress on the automatic pipette system. That is, the membrane 115 may be easily pierced by a pipette, syringe or needle that may be part of a pipette-based material delivery system. In addition, the membrane 115 prevents any swab or other solid material that may already inside the specimen tube from being pulled out from specimen tube when the pipette is retracted. After piercing, the pierceable plugin cap 100 does not require removal. Thus, utilizing the plugin cap 100 to prevent material from escaping the specimen tube and to prevent swabs and/or other non-liquid material from being pulled out of specimen tubes will reduce labor time. Further the pierceable plugin cap 100 is designed to minimally increase the tube height, which avoids additional stress on both the automated pipette system and the tube rack, including any tube retaining bars.

In one embodiment, the membrane 115 may be a foil membrane adhered (via an adhesive) over the aperture at the top of the plugin cap 100 that can be pierced with a downward force of between two and three Newtons and specifically 2.4 N in a further embodiment. In other embodiments, the membrane 115 may be cloth, mesh, or plastic that are equally resistant to corrosion and other chemical level interactivity with the contents of a specimen tube, yet still provide a liquid-tight seal. Further, the shaft 104 and aperture portions of the plugin cap 100 may comprise plastic (polypropylene).

Conventional pierceable plugin caps are made with a material that typically requires a needle-like pipette system for piercing. Further, conventional pierceable closure caps may have slitted covers and foil seals, which are designed for a specific tube. However, these closure caps add to the total height of the tube and cap making use with certain automated system difficult and, sometimes, inoperable. Because the majority of automated diagnostic instruments are designed for the specific tube size (height and diameter), longer tube height tubes are non-compatible. Even if a hand-held instrument is able to handle a longer tube height with a pierceable closure cap, the piercing force needed to pierce the cap (designed for a needle-like piercing) still stresses the pipette system, which can be a root cause of pipette error and/or failure.

Unlike traditional caps, which are designed for single purposes—either to seal the tube or to be pierceable but requiring removal, the pierceable plugin cap 100 combines these functions seamlessly. This innovation simplifies handling of swabs in transport media, enhancing efficiency of processing specimens. Additionally, a pierceable plugin cap 100 with a foil membrane 115 does not require a pipette system that has high piercing force or a needle-like tip.

Further, in a clinical diagnostic lab, any remaining samples after initial diagnostics must be retained for a certain period of time for future analysis and diagnostics. The tested specimen needs a closure cap for storage. Because this pierceable plugin cap 100 does not interfere with the thread neck (or threaded area of the closure interface) of specimen tubes, the original tube closure cap can be placed over the plugin cap 100 for storage. Removing a used plugin cap 100 after analysis might introduce contamination of the environment and pose a risk of specimen alteration. Avoiding removal of the used plugin cap 100 is highly preferred procedure.

Thus, in this embodiment, the pierceable plugin cap 100 comprises a cylindrical plugin aperture having a top end 110, a bottom end 105 and a plugin aperture body 104 disposed between the top end 110 and the bottom end 105, wherein the bottom end 105 comprises a diameter that is smaller than the top end 110. The pierceable plugin cap further comprises a plurality of sealing rings 106, 107, and 108 disposed on an outer circumference of the plugin aperture body 104, the plurality of sealing rings configured to secure the plugin aperture body 104 to a specimen tube aperture in a water-tight sealed manner. The pierceable plugin cap 100 further comprises a membrane 115 disposed over the top end 110 to cover the plugin aperture to form a liquid tight seal, the membrane 115 configured to be pierced by a pipette such that the piercing pipette may pass through the plugin cap aperture.

FIG. 2 is a plan view of the pierceable plugin cap 100 of FIG. 1 according to an embodiment of the subject matter disclosed herein. As before, the plugin cap 100 comprises a narrow end 105 having a diameter suited to fit inside a standard specimen tube. Further, the narrow end 105 is slightly tapered to facilitate entry into the open end of a specimen tube and is the culmination of a shaft portion 104 of the plugin cap 100 suited to securely fit inside the specimen tube. The plugin cap 100 further comprises a top end 110 that has a diameter that is larger than an open aperture of a specimen tube such that when the plugin cap 100 is inserted into the specimen tube aperture, the top end comes into to contact with the lip of the specimen tube aperture and prevents the plugin cap 100 from being pushed beyond the threshold of the specimen tube aperture. That is, the plugin cap 100 cannot be inserted beyond the top of the specimen tube and the portion 111 of the plugin cap 100 that remains protruding above the specimen tube aperture threshold is about 0.8 to 1.0 mm.

The shaft 104 of the plugin cap 100 may also include a plurality of sealing rings 106, 107, and 108 for engaging an inner circumference of the specimen tube when inserted to provide a liquid-tight seal. Thus, the sealing rings 106, 107, and 108 each provide a means for securing (via compression) the plugin cap 100 inside the top of the specimen tube and prevents materials (e.g., liquid) from getting in or out when the plugin cap 100 is securely inserted.

The pierceable plugin cap 100 includes an aperture 120 for facilitating passing a pipette through. In the plan view of FIG. 2, the aperture boundaries 121 are shown in dotted lines and indicate the boundaries of the interior cylindrical structure. Further, in this plan view of FIG. 2, the membrane 115 is shown as a thin foil adhered to the top side of the aperture 120 wherein the membrane 115 may be pierced by a non-needle pipette with a force of approximately 2.4 Newtons. The pierceable plugin cap 100 is designed to be placed inside of a specimen tube such that the top end 110 protrudes beyond the original threshold of the specimen tube by approximately 0.8-1.0 mm above the rim.

In this embodiment, the plugin cap 100 is designed to interface with a specimen tube having an outer diameter of 16 mm and an inner diameter of 14 mm. Other embodiments may be adapted to various diameters as long as the inner diameter of the plugin cap aperture 120 is sufficient for the analytical instrument pipette tip size of approximately 7 mm.

FIG. 3 is bottom view of the pierceable plugin cap 100 of FIG. 1 according to an embodiment of the subject matter disclosed herein. In this view, once can see the top end 110 and the bottom end forming the aperture 120 with the circumferential boundaries 121. The sealing rings 106, 107, and 108 are showing surrounding an outer circumference of the shaft 104 (not seen behind the bottom end 105). Further, extending beyond the bottom end is a lip 112 of the top end configured to engage a specimen tube when the plugin cap 100 is inserted in said specimen tube. As one peers through the aperture 120 from this view, the membrane 115 is visible.

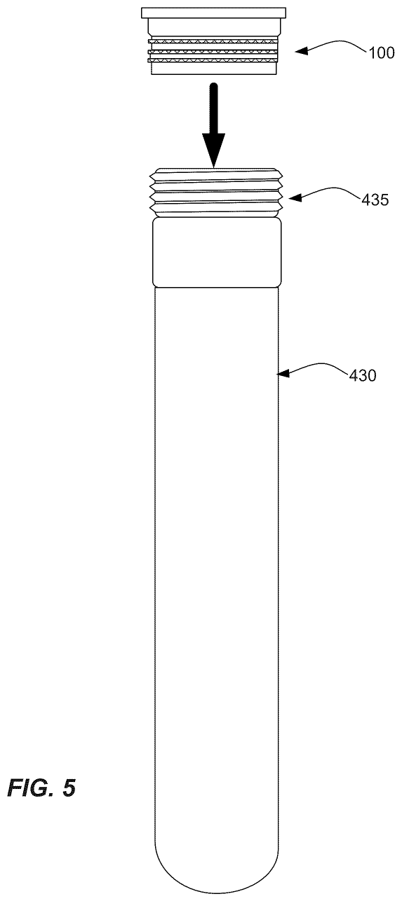

FIG. 4 is a plan view of a common specimen tube 400 suited for use with the pierceable plugin cap 100 of FIG. 1 according to an embodiment of the subject matter disclosed herein. The specimen tube 400 include a tube body 430 that is an elongated hollow cylinder with a closed end (bottom) and an open end (top) having an aperture for materials and testing equipment access. The aperture end of the specimen tube 400 may include threads 435 disposed around the outer circumference of the specimen tube 400 for engaging a matching sealing cap 440. Thus, the sealing cap may also include reciprocal threads (not shown) include the inner circumference of the sealing cap to screw the cap down over the aperture of the specimen tube. The pierceable plugin cap 100 is not shown in FIG. 4. Instead, the conventional sealing cap 440 is shown as engageable and disengageable with the specimen tube 400. FIGS. 5 and 6 discussed next show the pierceable plugin cap 100 engaging and engaged with the specimen tube 400.

FIG. 5 is a plan view of a common specimen tube 400 engaged with the pierceable plugin cap 100 of FIG. 1 according to an embodiment of the subject matter disclosed herein. As before in FIG. 4, the specimen tube 400 include a tube body 430 that is an elongated hollow cylinder with a closed end (bottom) and an open end (top) having an aperture for materials and testing equipment access. The aperture end of the specimen tube 400 may include threads 435 disposed around the outer circumference of the specimen tube 400 for engaging a matching sealing cap (not shown in FIG. 5). Instead, in FIG. 4, the pierceable plugin cap 100 of FIG. 1 is shown as about to be engaged with the specimen tube. FIG. 6 discussed next show the pierceable plugin cap 100 engaged with the specimen tube 400.

FIG. 6 is a plan view of a common specimen tube 400 engaged with the pierceable plugin cap 100 of FIG. 1 according to an embodiment of the subject matter disclosed herein. In this view, the threads 435 disposed at the top side of the specimen tube 400 are shown as cutaway to reveal the engaged plugin cap 100 seated inside the aperture of the specimen tube 400. The membrane 115 of the plugin cap 100 remains disposed over the aperture of the plugin cap 100 thereby also covering the aperture of the specimen tube 400.

The specimen tube 400 and plugin cap 100 system of FIG. 6 may be depicted in state wherein any specimen transport media and/or specimen sample material may be already inside the specimen tube 400 and sealed therein by the plugin cap 100. The specimen samples (not shown inside the specimen tube) may be chips from a dried blood spot (DBS) card received from a remote patient. The specimen samples may also be a swab prepared by a remote patient collecting vaginal or rectal materials. As is discussed below, in an automated system (FIG. 7) for preparing and testing sample materials in specimen tubes, pipettes used to deliver material to the specimen tube 400 sometimes engage the enclosed swab or swab stick such that the enclosed swab or swab stick may be pulled out of the specimen tube when the pipette is retracted. However, a specimen tube 400 having a pierceable plugin cap 100 in situ prevents any materials that may adhere to the inserted pipette from being pulled out when the pipette is retracted because the membrane 115 is only pierced at the diameter of the pipette (in one embodiment, 7 mm) and the hole in the now pierced membrane 115 is too small to allow the swab or other material to pass through the pieced hole.

Thus, FIG. 6 shows an embodiment of a specimen tube system, comprising a specimen tube 400 having a cylindrical body with a specimen tube aperture on a tube end exposing a holding area inside the cylinder and a pierceable plugin cap 100 engageable with the specimen tube 400. The specimen tube system further comprises threads 435 disposed on an outer circumference of the specimen tube 400 adjacent to the specimen tube aperture. The specimen tube system may further comprise a specimen tube cap (440 of FIG. 4) having threads on an inside circumference configured to engage the threads of the specimen tube in a water-tight sealed manner.

FIG. 7 is system view of an automated pipette system 700 suited for use with an array of specimen tubes 701 each fitted with the pierceable plugin cap 100 of FIG. 1 according to an embodiment of the subject matter disclosed herein. The system 700 may include an array of specimen tubes 701 set on a staging platform 750 and held individually upright by a specimen tube holder 770. Each individual specimen tube 430 may contain remotely collected sample materials sealed inside by a respective pierceable plugin cap 100 with a respective pierceable membrane 115.

The specimen tube system 700 may also include an automated material dispensing system having at least one pipette configured to penetrate the membrane of a specific pierceable plugin cap 100 to deliver material into the corresponding specimen tube 430. In this embodiment, the automated material dispensing system comprises an upright structural member 755 and horizontal pipette actuator 756 that is configured to convey dispensable material to one or more pipettes 760. In this embodiment, each pipette 760 comprises a pointed end having a diameter of no more than 7 mm. In other embodiments, the pointed end of the pipette 760 may have a larger or smaller diameter with the caveat of having to fit inside the aperture of the pierceable plugin cap 100. The actuator 756 is configured to maneuver one or more pipettes to align with a respective specimen tube 430 and to lower the one or more pipettes 760 toward each respective specimen tube 430 to pierce the membrane 115 respective pierceable plugin cap 100. Once the pipette 760 is maneuvered inside the specimen tube 430, the media therein may be aspirated and/or additional materials (such as reagents) may be dispensed into the specimen tube 430. The actuator 756 may then retract the pipette 760 out of the specimen tube 430. Any swab (or other sample material) disposed inside the specimen tube 430 is maintained inside the specimen tube 430 after pipette 760 dispenses material and is maneuvered out of the specimen tube 430.

The specimen tube holder 770 may hold a plurality of specimen tubes 430 and is arranged in an array of bins wherein each bin is configured to hold one of the plurality of specimen tubes 430 upright such that a pipette 760 may be maneuvered into each upright specimen tube 430 by penetrating a respective pierceable plugin cap membrane 115 for delivery of materials through the pipette 760. In one embodiment, the holder 770 comprises and array of six by six.

Utilizing the system 700 of FIG. 7 enables a technician to perform a method for testing a specimen held in a specimen tube 430. In an embodiment, the method comprises collecting a specimen from a human in a remote location (e.g., away from a laboratory setting such as at home) and then receiving the remotely collected specimen at a local laboratory. The technician may then prepare an elution using the received specimen in a specimen tube 430 and then insert a pierceable plugin cap 100 in the specimen tube 430. Once the specimen tube 430 is sealed, the technician may continue by placing the sealed specimen tube 430 in a testing system array (e.g., holder 770) and maneuvering a pipette 760 to the specimen tube 430 and piercing the membrane 115 with the pipette 760 such that the pipette 760 enters the specimen tube 430 while the membrane 115 remains adhered to an aperture of the specimen tube 430. When pierced, the technician may enable dispensing material into the specimen tube 430 and retracting the pipette 760 from specimen tube 430 such that materials (e.g., a swab or a swab stick) in the specimen tube 430 remain in the specimen tube. One or more of these steps may be automated without enablement or initiation by the technician.

The method may further comprise placing a screw cap (440 of FIG. 4) over the plugin cap 100 to reseal the materials in the specimen tube 430 before, during, or after elution preparation. In other embodiments, the collector of the remote specimen (e.g., the patient) may also place the collected sample in the specimen tube 430, place the pierceable plugin cap 100 to seal the specimen tube 430 and then place a transportation sealing cap over the pierceable plugin cap 100 for shipping to the laboratory for processing and testing. At the laboratory, the testing system may also include automation to remove a top cap (e.g., shipping or transport cap 440 of FIG. 4) from the specimen tube 430 prior to piercing any membrane 115 or dispensing any materials through any pipette 760. Further, the testing system 700 may be configured to dispense materials into each respective specimen tube 430 over multiple iterations such that piercing a respective membrane 115 a second time after the first dispensing of material is accomplished to dispense at least a second material. Of course, the membrane 115 already has a piercing from the initial piercing, so the pipette 760 will more easily be inserted through the already pierced portion of the membrane 115.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

That which is claimed is:

1. A pierceable plugin cap for a specimen tube, comprising:
a cylindrical aperture having a top end and a bottom end, and an aperture body disposed between the top end and the bottom end, wherein the bottom end comprises a diameter that is smaller than the top end;
a plurality of sealing rings disposed on an outer circumference of the aperture body, the plurality of sealing rings configured to secure the cylindrical aperture to an opening of a specimen tube in a water-tight sealed manner; and
a membrane disposed over the top end to cover the aperture to form a liquid tight seal, the membrane configured to be pierced by a pipette such that the piercing pipette may pass through the aperture.

2. The pierceable plugin cap of claim 1, wherein the membrane comprises a foil that may penetrated by a force of approximately 2.4 Newtons.

3. The pierceable plugin cap of claim 1, wherein aperture is approximately 12 mm in diameter.

4. The pierceable plugin cap of claim 1, wherein membrane comprises one from the group composed of foil, plastic, mesh and cloth.

5. The pierceable plugin cap of claim 1, wherein membrane comprises one or more materials that do not chemically react with contents of an engaged specimen tube,

6. The pierceable plugin cap of claim 1, wherein the plurality of sealing rings comprises three sealing rings.

7. The pierceable plugin cap of claim 1, wherein narrow end comprises a diameter of 13 mm.

8. The pierceable plugin cap of claim 1, further comprising a top cap disposed contagious with the aperture body and having a diameter that prevents the aperture body from moving beyond a threshold of a specimen tube when engaged with the specimen tube, the top cap having a depth of less than 4 mm.

9. A specimen tube system, comprising:
a specimen tube having a cylindrical body with a specimen tube aperture on a tube end exposing a holding area inside the cylinder; and
a pierceable plugin cap engageable with the specimen tube, having:
a cylindrical plugin aperture having a top end, a bottom end and a plugin aperture body disposed between the top end and the bottom end, wherein the bottom end comprises a diameter that is smaller than the top end;
a plurality of sealing rings disposed on an outer circumference of the plugin aperture body, the plurality of sealing rings configured to secure the plugin aperture body to the specimen tube aperture in a water-tight sealed manner, and
a membrane disposed over the top end to cover the plugin aperture to form a liquid tight seal, the membrane configured to be pierced by a pipette such that the piercing pipette may pass through the plugin aperture.

10. The specimen tube system of claim 9, further comprising:
threads disposed on an outer circumference of the specimen tube adjacent to the specimen tube aperture; and
a specimen tube cap having threads on an inside circumference configured to engage the threads of the specimen tube in a liquid-tight sealed manner.

11. The specimen tube system of claim 9, further comprising:
an automated material dispensing system having at least one pipette configured to penetrate the membrane of the pierceable plugin cap to deliver material into the specimen tube, the pipette comprising a pointed end having a diameter of no more than 7 mm.

12. The specimen tube system of claim 9, further comprising:
at least one pipette configured to dispense material into specimen tubes; and
an actuator configured to maneuver the pipette in and out of the specimen tube.

13. The specimen tube system of claim 12, further comprising a swab disposed inside the specimen tube wherein the pierceable plugin cap is configured to maintain the swab inside the specimen tube after the at least one pipette dispenses material and is maneuvered out of the specimen tube.

14. The specimen tube system of claim 9, further comprising a holder for a plurality of specimen tubes, the holder arranged in an array of bins wherein each bin is configured to hold one of the plurality of specimen tubes upright such that a pipette may be maneuvered into each upright specimen tube by penetrating the membrane for delivery of materials through the pipette into the specimen tube.

15. A method for testing a specimen held in a specimen tube, the method comprising:
collecting a specimen from a human in a remote location;
receiving the remotely collected specimen at a local laboratory;
prepare an elution using the received specimen in specimen tube;
inserting a pierceable plugin cap in the specimen tube, the pierceable plugin cap having a membrane that seals the specimen in the specimen tube;
placing the sealed specimen tube in a testing system array;
maneuvering a pipette to the specimen tube and piercing the membrane with the pipette such that the pipette enters the specimen tube while the membrane remains adhered to an aperture of the pierceable plugin cap;
dispensing material into the specimen tube; and
retracting the pipette from specimen tube such that materials in the specimen tube remain in the specimen tube.

16. The method of claim 15, further comprising placing a screw cap over pierceable plugin cap to reseal the materials in the specimen tube.

17. The method of claim 15, further comprising preventing a swab from being pulled out of specimen tube when the pipette is retracted.

18. The method of claim 15, further comprising:
placing the specimen the specimen tube remotely;
placing the pierceable plugin cap;
placing a top cap over the plugin cap remotely; and
shipping the specimen tube having the plugin cap and the top cap to the local laboratory.

19. The method of claim 15, further comprising piercing the membrane a second time after the first dispensing of material to dispense at least a second material.

20. The method of claim 15, further comprising automatically removing a top cap from the specimen tube prior to piercing the membrane.
